(19) United States
(12) Patent Application Publication
(10) Pub. No.: US 2025/0297649 A1
(43) Pub. Date: Sep. 25, 2025

(54) DYNAMIC ENGAGEMENT SLIP-CLUTCH DEVICES AND SYSTEMS

(71) Applicant: ECA Medical Instruments, Thousand Oaks, CA (US)

(72) Inventor: Christopher Bell, Thousand Oaks, CA (US)

(21) Appl. No.: 19/208,470

(22) Filed: May 14, 2025

Related U.S. Application Data
(60) Provisional application No. 63/567,576, filed on Mar. 20, 2024.

(51) Int. Cl. F16D 7/02

(52) U.S. Cl. CPC F16D 7/024; F16D 2200/0004; F16D 2200/0056

(57) ABSTRACT

This disclosure includes devices and systems incorporating dynamic engagement slip-clutch. Such devices and systems may include a top clutch and a bottom clutch, each comprising a plurality of lobes, humps, ramps, or peaks, and/or a plurality of valleys or flats. Some embodiments of devices and systems incorporating a dynamic engagement slip-clutch additionally comprise a washer between the top clutch and bottom clutch to separate their respective lobes, humps, ramps, or peaks and/or valleys or flats while at rest such that rotation of one of said top and bottom clutches relative to the other clutch causes the plurality of lobes, humps, ramps, or peaks to engage with the corresponding features of the corresponding clutch.

### RELATED APPLICATIONS

This application claims the benefit of U.S. Prov. Pat. App. No. 63/567,576, entitled “DYNAMIC ENGAGEMENT SLIP-CLUTCH DEVICES AND SYSTEMS” and filed on Mar. 20, 2024, the entire description, claims, and drawings of which is fully incorporated by reference herein.

### BACKGROUND OF THE INVENTION

### Related Field

The present disclosure relates generally to slip-clutch systems and devices, and specifically, to systems and devices that incorporate dynamic engagement and slip clutches.

### Description of the Related Art

Slip clutches are used in a variety of applications, including torque transmission and torque-limiting applications. Clutches typically include first and second members movable relative to one another and a means of providing a selected amount of torsional friction between the two members so that relative motion of the two members occurs only when they are subjected to a torque which exceeds a predetermined “slip” or “break away” torque associated with the clutch. In some instances, the two members have a set of “ramps” or humps in between them. Typically, these members' faces are in contact or flush at rest. When in movement, the friction between the members may cause unnecessary galling and deterioration.

### SUMMARY

Embodiments of the present disclosure prevent galling of slip clutch members.

These and other further features and advantages of the invention would be apparent to those skilled in the art from the following detailed description, taken together with the accompanying drawings, wherein like numerals designate corresponding parts in the figures, in which:

### BRIEF DESCRIPTION OF THE DRAWINGS

FIG. 1 shows an exploded view of a slip-clutch system embodiment according to the present disclosure;

FIG. 2 shows a front view of the slip-clutch system of FIG. 1 at rest;

FIG. 3 shows a front view of the slip-clutch system of FIG. 1 in rotation;

FIG. 4 shows a transparent front view of the slip-clutch system of FIG. 1 in rotation; and

FIG. 5 shows a bottom view of the slip-clutch system of FIG. 1. without the bottom slip clutch

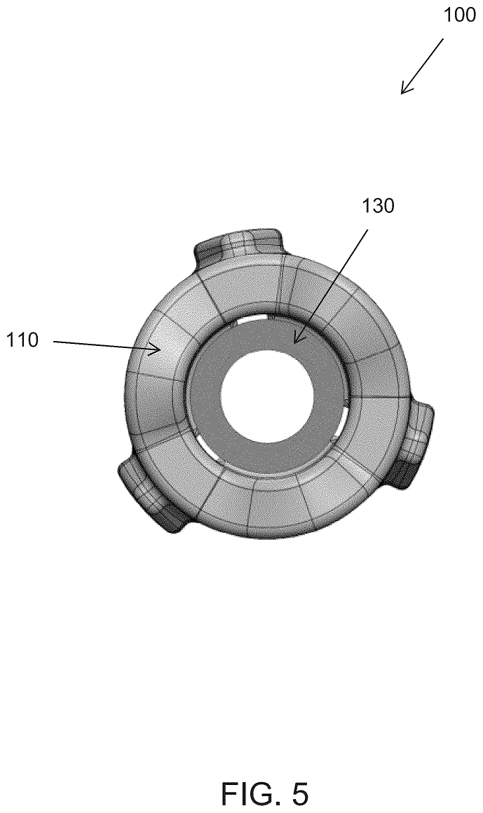

### DETAILED DESCRIPTION

In the following detailed description, numerous specific details are set forth in order to provide a more thorough understanding of embodiments incorporating features of the present disclosure. However, it will be apparent to one skilled in the art that devices and methods according to the present disclosure can be practiced without necessarily being limited to these specifically recited details.

Throughout this description, embodiments and examples illustrated should be considered as exemplars, rather than as limitations on the present disclosure. As used herein, the term “invention,” “device,” “method,” “present invention,” “present device,” or “present method” refers to any one of the embodiments of the disclosure described herein, and any equivalents. Furthermore, reference to various feature(s) of the “invention,” “device,” “method,” “present invention,” or “present device,” or “present method” throughout this document does not mean that all claimed embodiments or methods must include the referenced feature(s).

Furthermore, any element in a claim that does not explicitly state “means for” performing a specified function, or “step for” performing a specific function, is not to be interpreted as a “means” or “step” clause as specified in 35 U.S.C. § 112, for example, in 35 U.S.C. § 112(f) or pre-AIA 35 U.S. C. § 112, sixth paragraph. In particular, the use of “step of” or “act of” in the claims herein is not intended to invoke the provisions of 35 U.S.C. § 112.

It is also understood that when an element or feature is referred to as being “on” or “adjacent” to another element or feature, it can be directly on or adjacent the other element or feature or intervening elements or features may also be present. It is also understood that when an element is referred to as being “attached,” “connected” or “coupled” to another element, it can be directly attached, connected or coupled to the other element or intervening elements may be present. In contrast, when an element is referred to as being “directly attached,” “directly connected” or “directly coupled” to another element, there are no intervening elements present.

Please note, if used, relative terms such as “left,” “right,” “front,” “back,” “top,” “bottom′” “forward,” “reverse,” “clockwise,” “counter-clockwise,” “outer,” “inner,” “above,” “upper,” “lower,” “below,” “Horizontal,” “vertical,” and similar terms, have been used for convenience purposes only and are not intended to imply any particular fixed direction. Instead, they are used to reflect relative locations and/or directions between various portions of an object.

Although ordinal terms, e.g., first, second, third, etc., may be used herein to describe various elements or components, these elements or components should not be limited by these terms. These terms are only used to distinguish one element or component from another element or component. Thus, a first element or component discussed below could be termed a second element or component without departing from the teachings of the present invention.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” when used herein, specify the presence of stated features, integers, steps, operations, elements, and/or components, but do not preclude the presence or addition of one or more other features, integers, steps, operations, elements, components, and/or groups thereof.

Embodiments of the invention are described herein with reference to different views and illustrations that are schematic illustrations of idealized embodiments of the invention. As such, variations from the shapes of the illustrations as a result, for example, of manufacturing techniques and/or tolerances are expected. Embodiments of the invention should not be construed as limited to the particular shapes of the regions illustrated herein, but are to include deviations in shapes that result, for example, from manufacturing.

It is understood that when a first element is referred to as being “between” or “interposed between” two or more other elements, the first element can be directly between the two or more other elements or intervening elements may also be present between the two or more other elements. For example, if a first element is “between” or “interposed between” a second and third element, the first element can be directly between the second and third elements with no intervening elements, or the first element can be adjacent to one or more additional elements with the first element and these additional elements all between the second and third elements.

Some embodiments incorporating features of the present disclosure are single-use or disposable. Other embodiments are meant for multi-use and/or continuous use.

Embodiments disclosed herein may be utilized in certain torque-limiting devices or within attachments. Torque-limiting devices or attachments typically prevent over-torquing and under-torquing in medical devices and may comprise a speed reduction mechanism, a torque-limiting system, and a locking mechanism that allows a manufacturer, or even a user (e.g., a surgeon), to set the output torque limit of the attachment or device. More specifically, embodiments of a slip-clutch system disclosed herein may be used in a power-driven torque-limiting attachment.

At least one advantage of systems and devices incorporating features of the present disclosure is that the design of the slip-clutch system prevents galling of the components and improves longevity of the devices and systems.

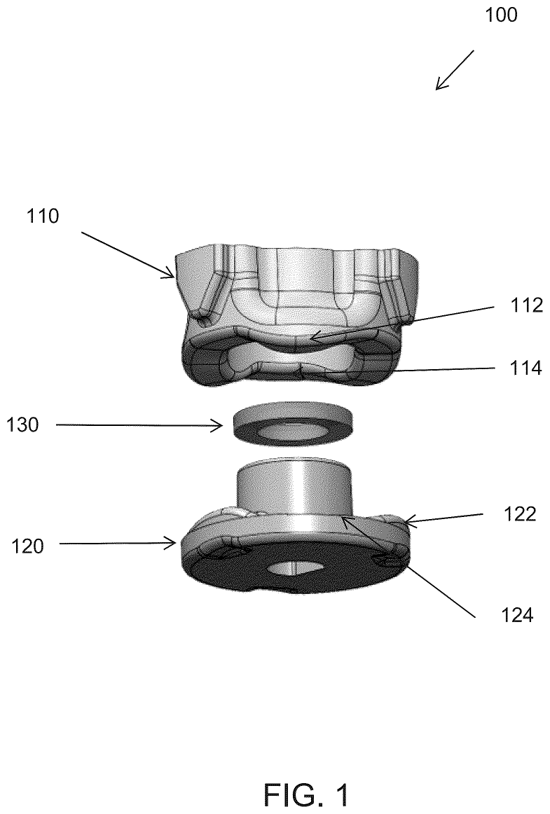

As shown in FIG. 1, one embodiment of a slip-clutch system 100 incorporating dynamic engagement comprises a top slip clutch 110, a bottom slip clutch 120, and a washer 130. In the embodiment shown, the top slip clutch 110 and the bottom slip clutch 120 have faces with peaks or humps 112, 122 and valleys or flats 114, 124 that are configured to mate.

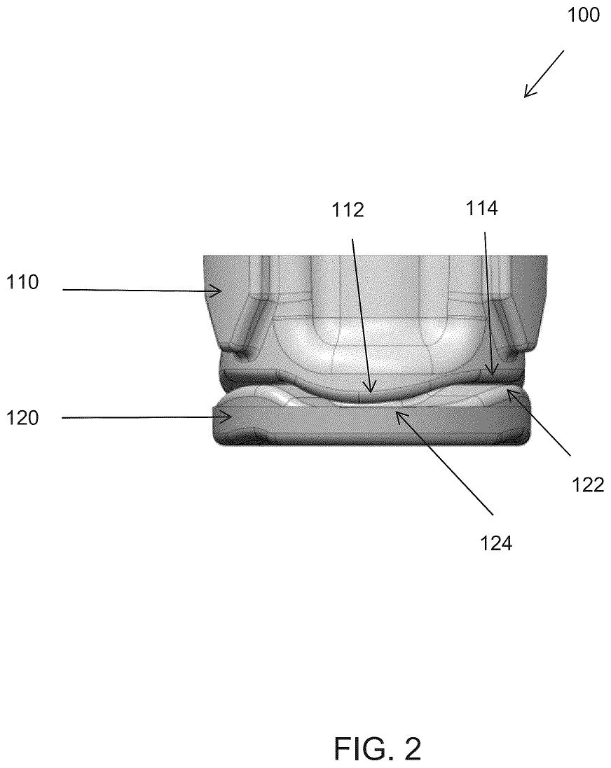

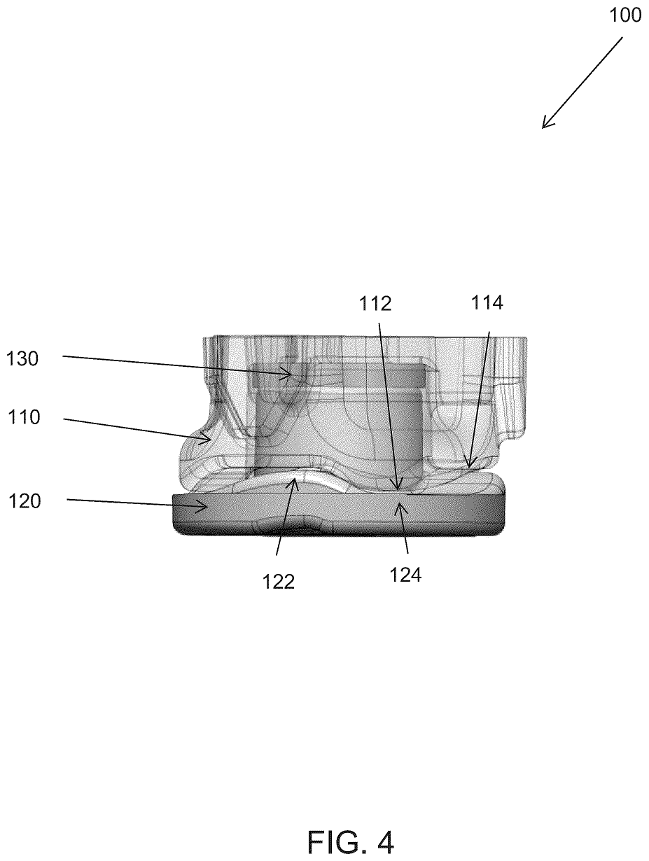

As shown in FIGS. 1 and 2, the washer 130 is configured to be placed between the top slip clutch 110 and the bottom slip clutch 120 such that, when the clutches 110, 120 are at rest, the peaks 112, 122 and valleys 114, 124 of each clutch 110, 120 do not contact. Without the washer 130, the top slip clutch 110 and the bottom slip clutch 120 would touch when at rest. The positioning of the washer 130 in a preferred embodiment of the present disclosure is best shown in FIG. 4.

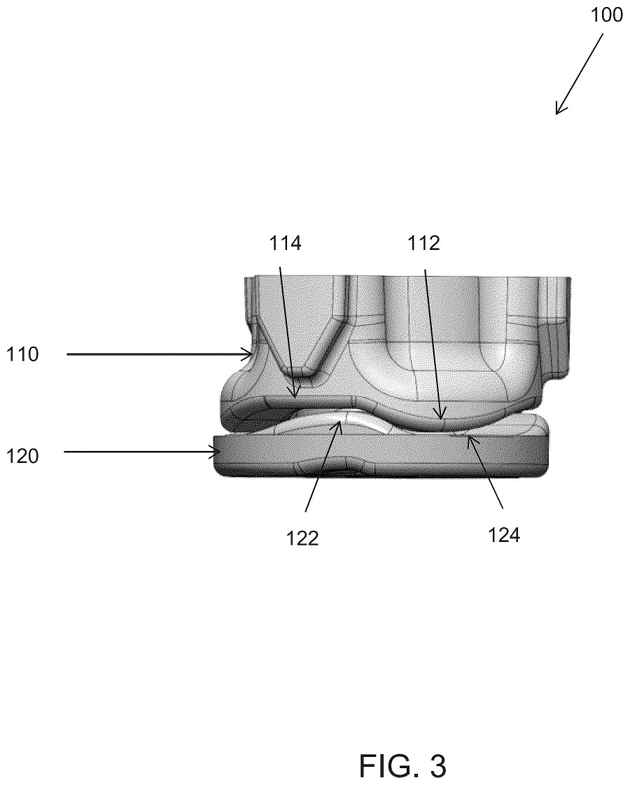

As shown in FIG. 3, when the clutches 110, 120 are rotated relative to one another, the respective peaks 112, 122 of the slip clutches 110, 120 come into contact.

In a preferred embodiment, the slip clutch system 100 according to this disclosure is used at high rotational speed. Configuring the clutches 110, 120 not to contact or touch at rest and only when they are rotated into the other one, the clutches 110, 120 do not experience friction between the axial faces when rotation starts. They approach contact with velocity, so friction is also limited when the clutches make contact and slip on each other. This reduced friction prevents the clutches 110, 120 from galling or deteriorating, which would normally occur due to pressure, friction, and translation against each other.

The washer 130 may be comprised of light-weight, durable materials such as polymers (e.g., polyether ether ketone, polyphenylene sulfide, polyimide, or polyethylenimine), polymer resins, metals, metallic alloys, or other suitable materials as would be understood by one of skill in the art. The clutches 110, 120 may comprise the same materials or different materials for example durable metals such as aluminum, steel, magnesium, zinc, zinc-aluminum, or brass, or alloys of one or more of the foregoing.

One embodiment of a dynamic engagement device 200 (not pictured) incorporating a slip clutch 205 according to the present disclosure may include a top slip clutch 210 (which may be the same as or similar to the top slip clutch 110), a bottom slip clutch 220 (which may be the same as or similar to the bottom slip clutch 120), and a washer 230 (which may be the same as or similar to the washer 130). Some embodiments of a dynamic engagement device 200 include a top shaft 215 connected to the top slip clutch 210 and/or a bottom shaft 225 connected to the bottom slip clutch 220. In specific embodiments, a motor 240 is attached to one of the top slip clutch 210 or the bottom slip clutch 220. As one of skill in the art would understand, the motor 240 may be attached to one of the top or bottom slip clutch 210, 220 through, for example, linkages, chains, belts, bands, etc.

The top and bottom slip clutches 210, 220 may, in some embodiments have faces with peaks or humps 212, 222 (which may be the same as or similar to the peaks or humps 112, 122) and/or valleys or flats 214, 224 (which may be the same as or similar to the valleys or flats 114, 124) that may be configured to mate. The washer 230 may be placed between the top and bottom slip clutches 210, 220 such that when the top and bottom slip clutches 210, 220 are at rest, their respective peaks 212, 222 do not touch.

The motor 240 can drive the top shaft 210 or the bottom shaft 220 to create rotation of the top or bottom slip clutch 210, 220 (as the case may be) relative to the corresponding top or bottom slip clutch 210, 220. When the clutches 210, 220 are rotated relative to one another, their respective peaks 212, 222 come into contact and may frictionally engage or slip, depending on the relative torque.

Although the present disclosure has been described in detail with reference to certain preferred configurations thereof, other versions are possible. Embodiments of the present disclosure can comprise any combination of compatible features shown in the various figures, and these embodiments should not be limited to those expressly illustrated and discussed. Therefore, the spirit and scope of the invention should not be limited to the versions described above.

The foregoing is intended to cover all modifications and alternative constructions falling within the spirit and scope of the invention as expressed in any appended claims, wherein no portion of the disclosure is intended, expressly or implicitly, to be dedicated to the public domain if not set forth in the claims.

I claim:

1. A slip-clutch system, comprising:
a top clutch having a first face comprising a first plurality of lobes, each having a height;
a bottom clutch having a second face counterfacing said first face and comprising a second plurality of lobes, each having a height; and
a washer located between said top clutch and said bottom clutch configured to separate said first plurality of lobes and said second plurality of lobes when said top clutch and said bottom clutch are at rest.

2. The slip-clutch system of claim 1,
wherein said top clutch comprises a first plurality of valleys, each having a depth, on said first face; and
wherein said bottom clutch comprises a second plurality of valleys, each having a depth, on said second face.

3. The slip-clutch system of claim 2, wherein said first plurality of lobes are configured to mate with said second plurality of valleys.

4. The slip-clutch system of claim 3, wherein said first plurality of valleys are configured to mate with said second plurality of lobes.

5. The slip-clutch system of claim 4, wherein the heights of said first and second plurality of lobes are equal to the depths of said first and second plurality of valleys.

6. The slip-clutch system of claim 4, wherein said washer has a thickness, and said thickness is less than the height of said first and second pluralities of lobes.

7. The slip-clutch system of claim 6, wherein said first plurality of lobes is configured to frictionally engage said second plurality of lobes upon rotation of said top clutch relative to said bottom clutch.

8. The slip-clutch system of claim 7, wherein said first plurality of lobes is configured to slip on said second plurality of lobes upon the application of a predetermined torque to said top clutch relative to said bottom clutch.

9. The slip-clutch system of claim 7, wherein said first plurality of lobes is configured to slip on said second plurality of lobes upon the application of a predetermined torque to said bottom clutch relative to said top clutch.

10. The slip-clutch system of claim 1, where said top clutch and said bottom clutch each comprise a metallic alloy.

11. The slip-clutch system of claim 1, wherein said washer comprises a polymer.

12. A dynamic engagement device comprising:
a top clutch having a first face comprising a first plurality of peaks, each having a height;
a top shaft attached to said top clutch;
a bottom clutch having a second face counterfacing said first face and comprising a second plurality of peaks, each having a height;
a bottom shaft attached to said bottom clutch;
a washer having a thickness and located between said top clutch and said bottom clutch configured to separate said first plurality of peaks and said second plurality of peaks when said top clutch and said bottom clutch are at rest; and
a motor functionally attached to one of said top shaft and said bottom shaft.

13. The dynamic engagement device of claim 12,
wherein said top clutch comprises a first plurality of valleys, each having a depth, on said first face; and
wherein said bottom clutch comprises a second plurality of valleys, each having a depth, on said second face.

14. The dynamic engagement device of claim 13, wherein said first plurality of peaks are configured to mate with said second plurality of valleys.

15. The dynamic engagement device of claim 14, wherein said first plurality of valleys are configured to mate with said second plurality of peaks.

16. The slip-clutch system of claim 15, wherein the thickness of said washer is less than the height of said first and second pluralities of peaks.

17. The dynamic engagement device of claim 16, wherein said first plurality of peaks is configured to frictionally engage said second plurality of peaks upon rotation of said top clutch relative to said bottom clutch.

18. The dynamic engagement device of claim 17, wherein said first plurality of peaks is configured to slip on said second plurality of peaks upon the application of a predetermined relative torque between said top clutch and said bottom clutch.

19. The dynamic engagement device of claim 12, where said top clutch and said bottom clutch each comprise a metallic alloy.

20. The dynamic engagement device of claim 12, wherein said washer comprises a polymer.
